(19) United States
(12) Patent Application Publication
(10) Pub. No.: US 2010/0140914 A1
(43) Pub. Date: Jun. 10, 2010

(54) MEDICAL ORGANIZER

(76) Inventor: Laurel Stoll, Lee's Summit, MO (US)

Correspondence Address: ERICKSON, KERNELL, DERUSSEAU & KLEYPAS, LLC, 800 W. 47TH STREET, SUITE 401, KANSAS CITY, MO, 64112, US

(21) Appl. No.: 12/328,766

(22) Filed: Dec. 5, 2008

(51) Int. Cl. B42D 15/00

(52) U.S. Cl. 283/37; 283/2; 283/117; 283/900

(57) ABSTRACT

An organizer for assisting a medical patient to record information provided by a physician or other healthcare provider for later review by the patient or patient caregiver includes a front and back cover bound together and to interposed sheets, dividers and other materials disposed between the covers.

### BACKGROUND OF THE INVENTION

This invention relates to planners or organizers for recording contact information, medical information and dates, and, more particularly, to an organizer for medical patients or caregivers to record and organize information provided by treating physicians and other health care providers for later review by the patient, spouse or other caregiver, or physician, particularly information related to the treatment of chronic illnesses such as cancer.

The prior art includes various organizers, calendars, and other items for record keeping, some of which are intended for patients to record the dates of future office visits, symptoms experienced outside of the hospital or while away from caregivers, reminders to take medications, contact information, and dates and results of tests. The prior art does not include the combined and particular elements of the present invention, however, which provides an organizer developed particularly for use by medical patients with relatively long term, but often intermittent, medical conditions.

### BRIEF DESCRIPTION OF THE INVENTION

An organizer for medical patients to record information provided by physicians or other patient caregivers, for later review by the patient or patient caregiver, includes a front and back cover, bound together and to interposed sheets, dividers and other materials disposed between the covers and comprising the organizer. In one embodiment, the organizer includes a sheet with pockets for holding business cards, a sheet of adhesive labels bearing dates, a sheet bearing a printed calendar showing days of the week, month and year for a span of two years, a sheet bearing an appointment record, a sheet bearing lines for recording information obtained during office visits, a sheet bearing a chart for recording medications, a folder for storing current doctor reports, a folder for storing current test results, a plastic or paper gusseted bag for storing past doctor reports, and a plastic or paper gusseted bag for storing past test results.

Other advantages of the invention will become apparent from the following description taken in connection with the accompanying drawings, wherein is set forth by way of illustration and example an embodiment of the present invention.

### BRIEF DESCRIPTION OF THE DRAWINGS

FIG. 1 is a perspective view of a bound medical organizer.

FIG. 2 is a plan view of a sheet with pockets for holding business cards.

FIG. 3 is a plan view of a sheet of adhesive labels for bearing dates.

FIG. 4 is a plan view of a sheet bearing a printed calendar showing days of the week, month and year for a span of two years.

FIG. 5 is a plan view of a sheet bearing an appointment record.

FIG. 6 is a plan view of a sheet bearing lines for recording information obtained during office visits.

FIG. 7 is a plan view of a sheet bearing a chart for recording medications.

FIG. 8 is a plan view of a folder for storing current doctor reports or test results.

FIG. 9 is a plan view of a plastic or paper gusseted bag for storing past doctor reports.

FIG. 10 is a plan view of a plastic or paper gusseted bag for storing past test results.

FIG. 11 is a plan view of a registration card and a re-order card, both removable from the organizer and from each other via perforated tear lines.

### DETAILED DESCRIPTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

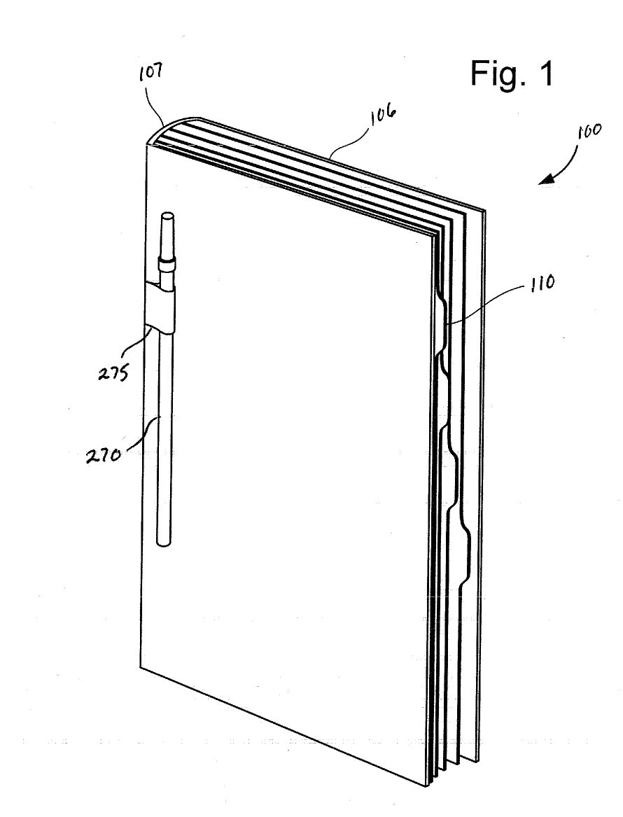

Referring now to FIGS. 1 through 11 of the drawings, there is shown in FIG. 1 an embodiment of the organizer of the present invention indicated by the reference numeral 100. The organizer 100 includes a front cover 105, back cover 106, and spine 107. The spine 107 connects the back cover 106 to the front cover 105 and also provides an attachment structure upon which to attach items bound within the organizer 100. Methods and materials used to bind items within the organizer 100 may include adhesive, wire, thread, or any operable means known in the art. Instructions for use of the organizer 100 are provided on the inside surface of the front cover 105 of the organizer 100 or on an adjacent page or pages.

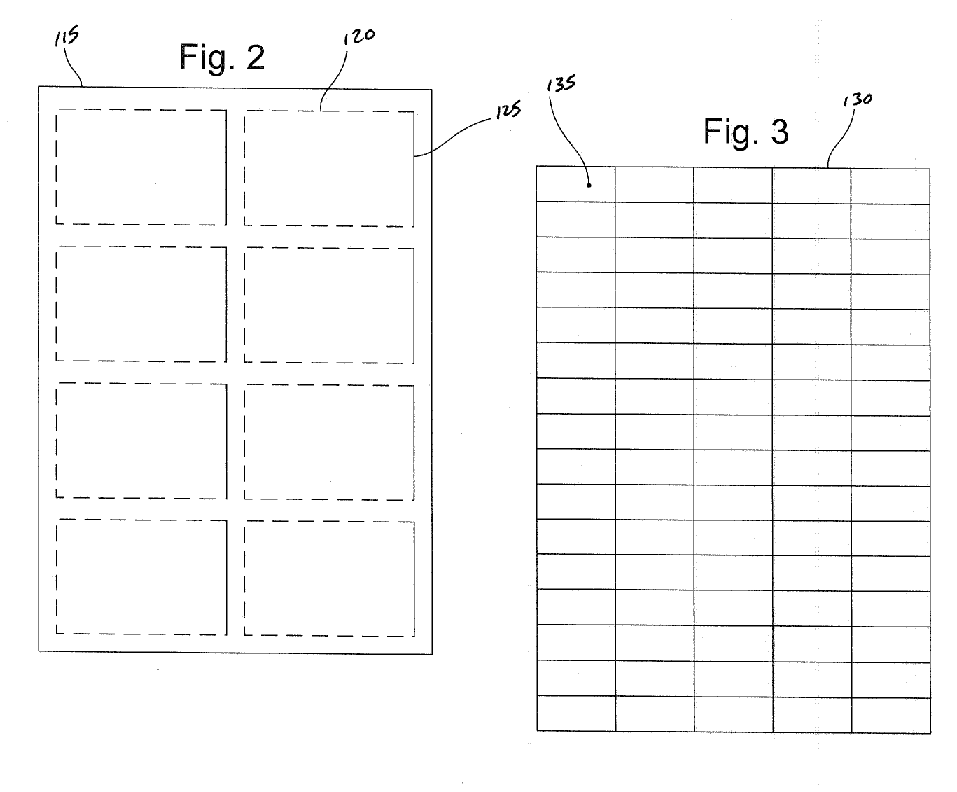

Tabbed dividers 110 are provided to divide the contents of the organizer into sections. Each tabbed divider 110 is typically provided with a descriptive term printed on the tab. An organizer 100 may include any number of tabbed dividers 110 desired by a patient receiving the organizer 100 or the organizer provider, within the structural limitations of the organizer 100. Although the embodiment disclosed herein describes an organizer 100 including eight tabbed dividers 110, only four tabbed dividers 10 are illustrated in FIG. 1 for clarity. A first tabbed divider 110 is followed by one or more plastic sheets 115 containing pockets 120 sized to accept and retain or hold business cards or cards of like dimensions, see FIG. 2. As business cards are collected from physicians and other healthcare or health service providers, they are inserted through pocket openings 125 and may be stored for ready later access in the card pockets 120.

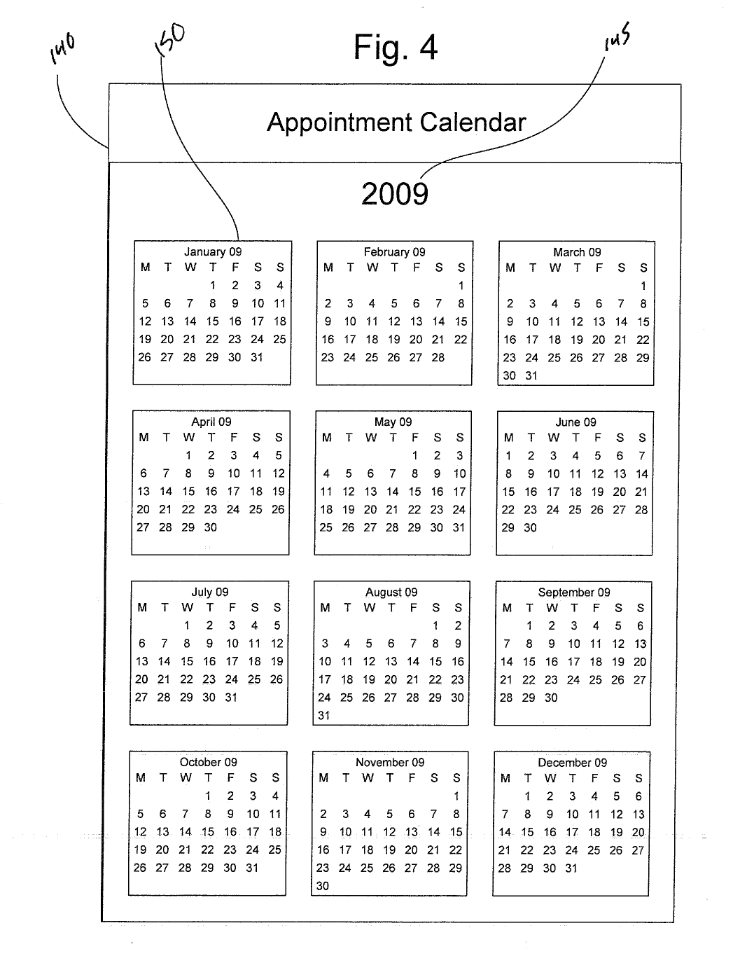

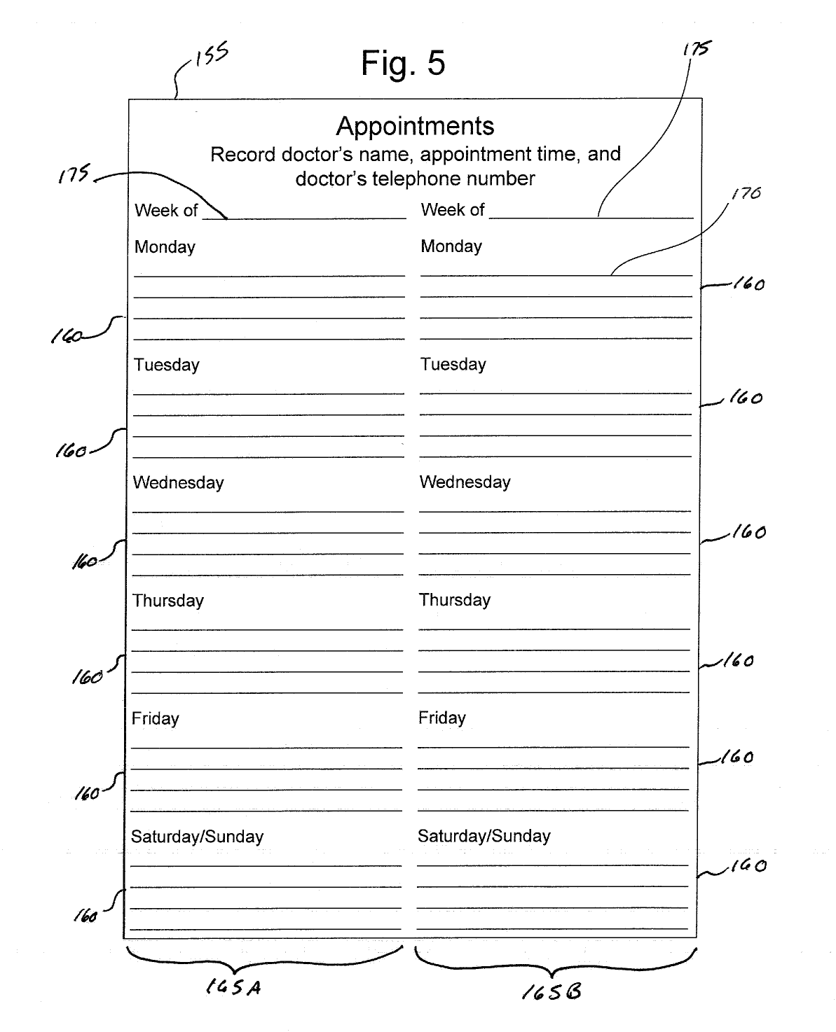

A second tabbed divider is followed by one or more sheets 130 of adhesive labels 135, see FIG. 3. The labels 135 each bear a pre-printed date corresponding to a Monday and typically a sufficient number of labels 135 to span two or more years, preferably at least five, are provided. A third tabbed divider is followed by a printed appointment calendar 140 showing all dates, days of the week, and months of the year for typically at least a span of two years. As shown in FIG. 4, each sheet of the appointment calendar may indicate the year 145 and display monthly calendars 150 for each month of the year. The appointment calendar 140 is followed by an appointment record 155 that provides appointment record entry locations 160 to write one or more entries for each day of the week, Monday through Sunday, see FIG. 5. Each page of the appointment record 155 includes two columns 165A and 165B. Each column lists the days of the week, starting at the top with Monday, and following down the column with Tuesday, Wednesday, Thursday, Friday, Saturday and Sunday. Beside each day of the week, several horizontal lines 170 are provided on which to place information. Above each column 165A and 165B, and near the location designated for Monday of that week, a space 175 is provided to place the sticker corresponding to the Monday date of that week.

Using this system provides enhanced flexibility as the appointment record 155 allows patients to use only columns in which there is information to be recorded on the associated dates. If a week or weeks progress in which there is no information to record, labeling of these weeks may be skipped in the appointment record 155 to avoid wasting space and paper. Labeling may then be resumed for the column immediately following the preceding entry. Sometimes cancer and other diseases or conditions go into remission but then resume weeks or months later. The appointment record 155 may be maintained only as needed. Information recorded in the appointment record may include the date, time and location of office visits, in which case the doctor name and telephone number typically should also be recorded.

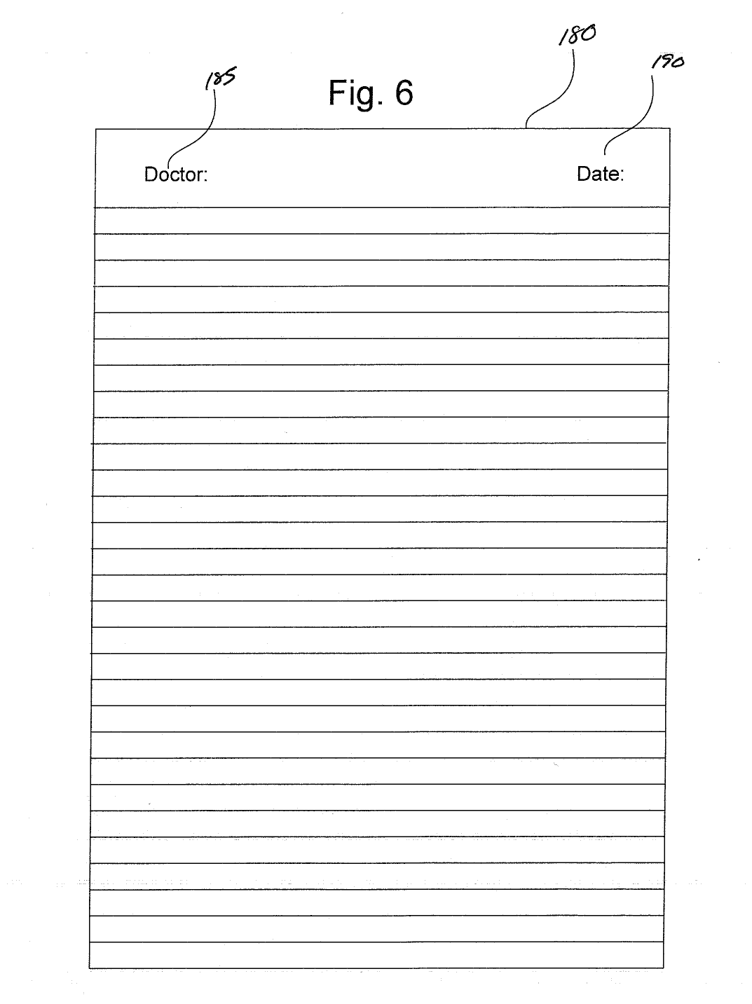

A fourth tabbed divider is followed by a journal 180 comprising a plurality of sheets of lined paper provided for a patient, relative, or caregiver to record notes during office visits, see FIG. 6. The terms “Doctor” 185 and “Date” 190 are printed at the top of each sheet, near the left and right corners thereof, respectively. These terms prompt recordation of the name of the doctor providing care and instruction during the visit and the date of the visit. Information recorded in the journal 180 is often highly valuable later, both for the patient to more fully understand the medical condition presented and the treatment plan, and for providing such information to caregivers or others who may assist the patient.

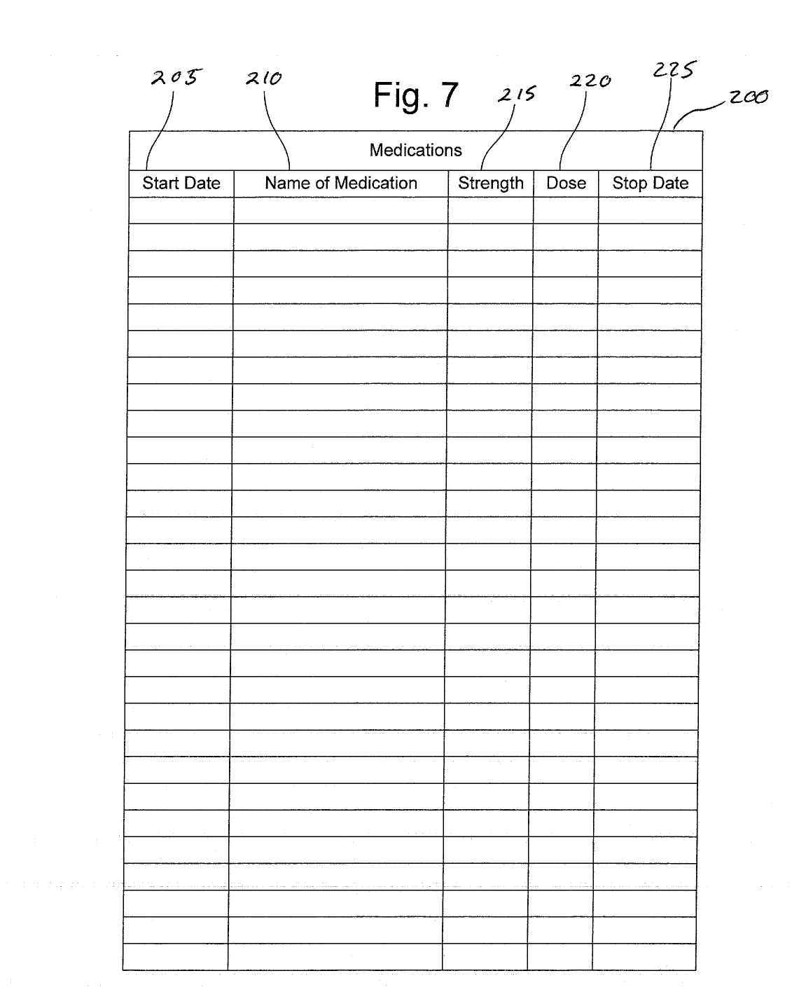

A fifth tabbed divider is followed by one or more sheets each bearing a chart 200 for recording medications and associated information, see FIG. 7. The chart 200 comprises columns and rows, with column headings including “Start Date” 205, “Name of Medication” 210, “Strength of Medication” 215, “Dose” 220 and “Stop Date” 225. The column headings 205 to 225 may vary depending on the specific intended use of a particular organizer 100. The medication chart 200 allows the patient to maintain a list of medications that may be tracked and presented to other caregivers. This provides a means for medication information from several doctors to be shared with one another and increases the patient's control and participation in assuring proper medical care. This information entered on the medication chart 200 can be valuable means to prevent overprescribing and overdosing of medications, as well as preventing the prescription of incompatible medications. The medication chart 200 provides a concise record of all medications and can be readily transported by the patient to appointments.

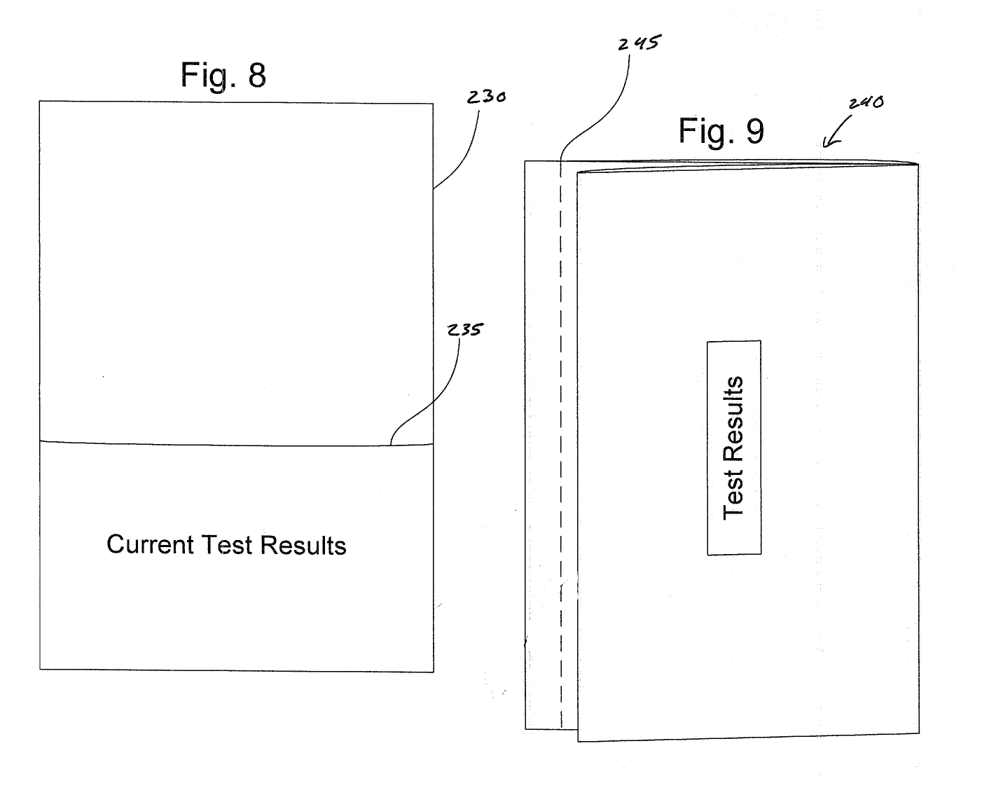

A sixth tabbed divider is followed by one or more plastic, paper or cardboard folders 230 for retaining documents. Folders 230 preferably include a pocket 235 on each side of the folder 230, one pocket 235 being designated for storing the most current doctor report, the other pocket designated for storing the most current test results, see FIG. 8.

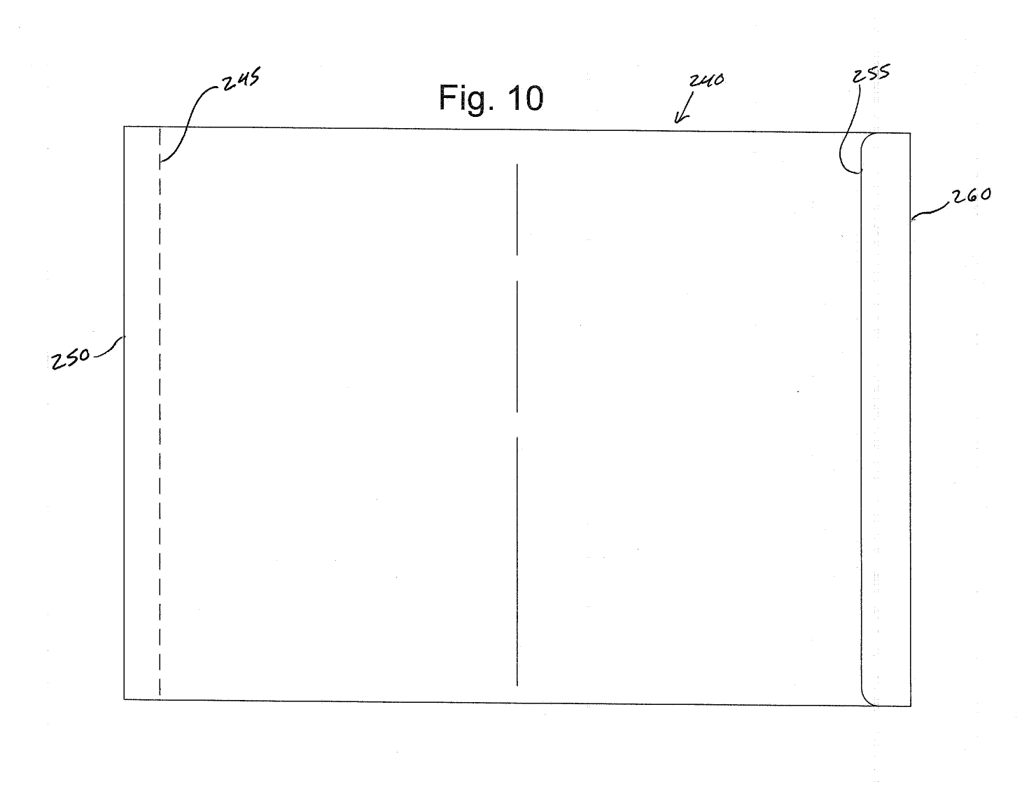

A seventh tabbed divider is followed by one or more plastic or paper gusseted bags 240 for storing past doctor reports, such as doctor reports moved from a folder 230 to make room for more current doctor reports. An eighth tabbed divider is followed by one or more plastic or paper gusseted bags 240 for storing past test results. Preferably, the bags 240 are each perforated 245 along a margin proximate the organizer spine 107, where the bag 240 attaches to the organizer 100. The bags 240 may be released from the organizer 100 for use (organized storage of past doctor reports and test results) by tearing along the perforation 245. FIG. 9 shows a bag 240 folded for positioning within an organizer 100. Broken line 245 indicates a perforated tear line. FIG. 10 shows the bag 240 of FIG. 9 fully opened. Line 245 in FIG. 10 indicates the tear line near the proximate end 250 of the bag 240 attached to and within the organizer 100. A flap 255 on the distal end 260 of the bag 240 serves as a bag closure. Once a bag 240 has been removed and opened to receive reports or results, the flap 255 (or other closure means) is closed or sealed to retain the reports or results within. The bag 240 may then be placed in storage.

For the convenience of the patient using the organizer 100, a writing utensil 270 may be provided and attached to the organizer 100 cover or spine via a loop 275 of plastic, fabric or of elastic material, or by other operable means.

A patient obtaining the organizer 100 from a physician, hospital or other health care provider will typically first review instructions, typically provided on or near an the inside surface of a cover 105 or 106, prepare the appointment record 155 so that it is ready to record appointments, record notes during the office or hospital visit into the journal 100, collect business cards and store them in the organizer pockets 120, ask for and then store reports in a folder 230, and arrange for and record subsequent appointments in the appointment record 155. Later, typically at home, the patient registers the organizer 100 online by entering owner-identifying information such as name, address, telephone number, and email address at an organizer provider and/or registration provider website. Organizer-identifying information, such as a serial or registration number printed on the organizer 100, is also entered during registration so that the specific organizer 100 may be associated with the owner in the registration record.

Alternatively, a registration card 280 is removed from the organizer 100 and filled out with owner-identifying information such as patient/owner name and address 285 and mailed to the organizer provider, at the provider address 290 pre-printed on the registration card 280, for registration. If misplaced, the organizer 100 may then be returned to the organizer provider address typically also posted on the inside surface of the back cover 106 of the organizer. A unique serial number 295 located on both the organizer 100 and on the registration card 280 will allow the provider to ascertain the name and address of the patient associated with an organizer 100 so that the organizer 100 may be returned by the provider to the patient.

By using either the online registration or card registration process, the owner of the organizer 100 may omit writing or otherwise disclosing owner-identifying information within or on the organizer itself, thereby maintaining owner (patient) privacy. The registration card 280, or a surface of the organizer 100 proximate the registration card 280 may bear a statement similar to the following to alert the owner to this privacy function: “For privacy, please register this number online or with the enclosed postcard.”

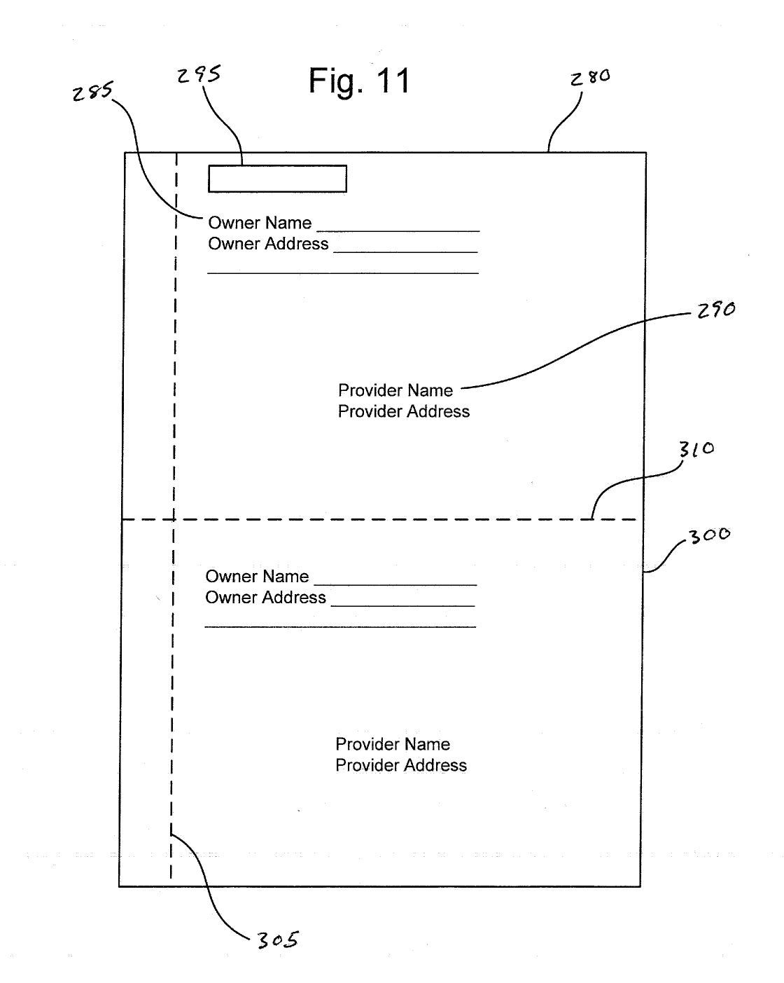

The organizer 100 may further include re-order card 300, typically of similar dimensions as the registration card 280. As shown in FIG. 11, a registration card 280 and a re-order card 300 may be provided on a single sheet of card stock bound within tile organizer 100. Both cards 280 and 300 are removable from the organizer 100 and from each other via perforated tear lines 305 and 310.

As a further alternative to online or card registration, the patient may write identifying information including name, address, telephone number, and email address on spaces provided on the inside surface of the back cover 106 so that the organizer 100 may be directly returned to the patient if misplaced. Space for instructions and advertising may also be provided on the inside surface of the front cover 105. Regarding the latter, advertisements or acknowledgements for a sponsoring organization or health care facility may also be placed on the outside surface of the front cover 105, the outside surface of the back cover 106 or at any selected location within the organizer 100.

A patient obtaining the organizer 100 from an agency or organization will typically first register the organizer 100 and then take the organizer 100 to all meetings or visits with health care providers.

A method for organizing personal medical information may include the following steps. An organizer 100 is provided comprising date-bearing adhesive labels 135, one or more calendars 140, an appointment record 155, a journal 180 for recording information, and means for registering the organizer 100, such as a registration card 280 or registration website url. The organizer appointment record 155 is prepared by moving an adhesive label 135 from the adhesive label sheet 130 to a page of the appointment record 155. The adhesive label 135 bears a date corresponding to the first listed day of the week (typically Monday) on the appointment record page. The label 135 is moved to an appointment record entry location 175 corresponding to this first listed day of the week. Dates subsequent to the first listed day (e.g. Tuesday, Wednesday, etc.) are entered in the corresponding appointment record entry locations 160. Medical appointment information is recorded at an appointment record entry location 160.

Notes comprising medical information received from a health care provider are recorded in the journal 180. Journal sheets are labeled “Doctor” and “Date” at the top of each sheet to remind the user to record the name of the health care provider and the date of the meeting or visit. Business cards received from doctors or other health care providers are stored in the plastic pockets 120 and any further appointments that are scheduled during the meeting or visit are entered in the appointment record 155 using date labels 135 peeled from the adhesive label sheets 130. The date labels 135 allow the appointment record 155 to be customized with date entries started and stopped as the medical condition enters or leaves remission. Therefore, sheets provided in sufficient number to cover a one or two year span may provide sufficient space to cover five or more years of entries.

As medications are prescribed the patient will fill Out the medications sheet 200 providing the date that a particular medication is started, the name of the medication, the strength of the medication, e.g. mg/tablet, the dose to take, e.g. 1 tablet per day, and the date that the patient should stop taking the medication. The patient may receive this information at an office visit or via other means such as prescriptions called in to a pharmacy.

The patient will likely receive test results and doctor reports from time to time. To organize these records, folders 230 and bags 240 are provided. A double-sided folder 230. (see FIG. 8) is provided with a pocket 235 on each side of the folder 230. One pocket 235 is for storing Current Test Results, the other pocket (not shown) is for storing Current Doctor Reports, and each pocket 235 is labeled as indicated. Gusseted bags 240 (see FIGS. 9 and 10) are provided for storing Test Results and Doctor Reports when they are moved from the Current folder 230. FIG. 9 shows a test result bag 240 folded over as stored within the organizer 100. FIG. 10 shows the same bag 240 folded open to extend the bag 240 to receive reports or results. The bag 240 is typically detached along a perforated line 245 (see broken line 245 proximate left bag margin 250) prior to inserting records or reports.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is as follows:

1. A medical organizer comprising:
a sheet with pockets for holding business cards,
a sheet of adhesive labels bearing dates,
a sheet bearing a printed calendar showing days of the week, month and year for a span of two years,
a sheet bearing an appointment record,
a sheet bearing lines for recording information obtained during office visits,
a sheet bearing a chart for recording medications,
a folder for storing current doctor reports,
a folder for storing current test results,
a gusseted bag for storing past doctor reports, and
a gusseted bag for storing past test results, said sheets folders and bags bound together to comprise said organizer.

2. The medical organizer of claim 1 wherein said sheets, folders, and bags are bound between a front cover and a back cover.

3. The medical organizer of claim 1 wherein at least one of said bags comprises plastic.

4. The medical organizer of claim 1 wherein at least one of said bags comprises paper.

5. An organizer for patient use to record and store medical information and associated dates and health care provider information, said organizer comprising:
instructions for use printed therein,
a plurality of pockets sized to accept and retain business cards,
adhesive labels bearing pre-printed dates,
an appointment calendar showing dates, days of the week, and months of the year for at period of at least one year,
an appointment record for entering appointment information,
a journal for recording information relating to a patient's medical condition,
a chart for recording medications and associated information,
one or more folders for retaining current medical documents, and
one or more detachable bags for storing medical documents.

6. The medical organizer of claim 5 wherein said pre-printed dates correspond to Mondays.

7. The medical organizer of claim 6 comprising a sufficient number of said labels bearing Monday dates to include all such dates over a period of at least two years.

8. The medical organizer of claim 5 further comprising a writing utensil attached to said organizer

9. The medical organizer of claim 5 further comprising a means for registering said organizer to associate said organizer with an owner of said organizer.

10. The medical organizer of claim 9 wherein said means for registering comprises a registration card, said card including means for recording owner-identifying information and organizer-identifying information.

11. The medical organizer of claim 9 wherein said means for registering comprises a webpage on the Internet, said webpage including means for receiving owner-identifying information and organizer-identifying information and storing an association between said owner-identifying information and said organizer-identifying information.

12. A method for organizing personal medical information, the method comprising the sequential or non-sequential steps of:
providing an organizer comprising date-bearing adhesive labels, one or more calendars, a journal for recording information, and means for registering said organizer,
preparing an appointment record by moving an adhesive label, said adhesive label bearing a date corresponding to the first listed day of the week in an appointment record, to an appointment record entry location corresponding to said first listed day of said week,
entering subsequent dates on appointment record entry locations corresponding to days of said week subsequent to said first listed day,
recording medical appointment information on an appointment record entry location, and
recording medical information received from a health care provider in said journal.
